(19) United States
(12) Patent Application Publication
(10) Pub. No.: US 2010/0215938 A1
(43) Pub. Date: Aug. 26, 2010

(54) METHOD OF SELECTIVE PLASTIC INSERT MOLDING ON METAL COMPONENT

(75) Inventors: Shaupoh WANG, Cupertino, CA (US); Sheng-Hung YI, Taichung County (TW); Yi-Chung SU, Taichung (TW)

Correspondence Address: ROSENBERG, KLEIN & LEE, 3458 ELLICOTT CENTER DRIVE-SUITE 101, ELLICOTT CITY, MD, 21043, US

(73) Assignee: TAIWAN GREEN POINT ENTERPRISES CO., LTD., Taichung County (TW)

(21) Appl. No.: 12/706,176

(22) Filed: Feb. 16, 2010

Related U.S. Application Data
(60) Provisional application No. 61/154,274, filed on Feb. 20, 2009.

(51) Int. Cl. B32B 7/08

(52) U.S. Cl. 428/223; 156/66

(57) ABSTRACT

This invention discloses a method of selective plastic insert molding on metal component and its product. A metal joint component is bonded with a metal component. After which, the joint component is submerged in plastic so that the molded plastic can be secured on the metal component firmly. Hence, a desired plastic structure can be formed on the metal component. This invention can shorten the manufacturing process and reduce the cost. In addition, it solves the traditional bonding problem between the plastic and the metal component as well as the problem concerning processing time and high cost.

### CROSS-REFERENCE TO RELATED APPLICATION

This application claims the benefit of the filing date of the U.S. Provisional Application No. 61/154,274, filed on Feb. 20, 2009, under 35 U.S.C. 119 (e) (1).

### BACKGROUND OF THE INVENTION

1. Field of the Invention

The present invention relates to a method of selective plastic insert molding on metal component. The metal joint component is bonded with a metal component. After which, the joint component is submerged in plastic so that the solidified plastic material can be secured on the metal component firmly. So, a structural member made by plastic material can be formed on the metal component.

2. Description of the Prior Art

If the housing of a mobile phone is made by metal, it will possess the metal's aesthetic appearance and unique touching feeling that is totally different to the ones of plastic. However, it is hard to bond plastic and metal together. If they are glued, the glued interface is not strong enough. So, the plastic material and the metal cannot be bonded firmly. That is, it is hard to form a plastic structural member on a metal component or housing directly. Under such circumstances, the following problems are generated for manufacturing a structural member or structural members.

[1] If a conventional pressing technology is applied, it is possible to punch or emboss a structural member with certain thickness (approximately 0.2 mm to 0.6 mm). But, it is hard to produce a structural member with different thickness or with a very complicated structure. Besides, once a metal housing of a mobile phone is punched, its surface becomes not smooth. The aesthetic appearance will be influenced.

[2] If a conventional precision die-casting technology is applied, the strength of the final product usually is insufficient. In addition, if a polishing process is used for refining its outer appearance, it is easy to cause breakage at the weakest portion of the product, especially when it is hit by an external force.

[3] If a conventional forging technology (cold forging, hot forging) is applied, it is possible to produce a structural member with different thickness. But, it is required to use an extra Computer Numerical Controlled (CNC) machining procedure to refine its outer surface. That generates the disadvantages of time-consuming and high cost.

[4] If a traditional Metal Insert Molding technology is utilized, it is required to enclose the entire metal component. The outer surface of the metal component is covered by plastic material. Hence, the original metal's aesthetic appearance and unique touching feeling are destroyed.

Therefore, the conventional methods still contain many problems mentioned above. It is needed to make further research and develop to overcome these problems.

### SUMMARY OF THE INVENTION

This invention is a method of selective plastic insert molding on metal component so that a plastic structural member can be formed on the metal component. It can shorten the manufacturing time and lower the cost. This invention can solve the problems such as the plastic material cannot be bonded on the metal component, the manufacturing time for the structural member is lengthy, the cost is too high, etc.

This invention is a method of selective plastic insert molding on metal component. It comprises the steps of: step 1: providing a metal component;

step 2: preparing a joint component;

step 3: the joint component being bonded with the metal component;

step 4: preparing a mold, the mold having a lower mold and an upper mold;

step 5: placing the bonded joint component and metal component in this mold;

step 6: injecting plastic material into the mold and then the joint component being submerged in the plastic material;

step 7: the plastic material being cooled and solidified; and

step 8: opening the mold so that a product consisting of plastic material combined with the metal component is obtained.

Also, the product manufactured by the method of the above-mentioned step 1 to step 8 is claimed in this invention.

### BRIEF DESCRIPTION OF THE DRAWINGS

FIG. 1 is the flowchart of the present invention.

FIG. 2 is a perspective view of the joint component of the first preferred embodiment of the present invention.

FIG. 3A is a view showing the step 1 of the first preferred embodiment of the present invention.

FIG. 3B is a cross-sectional view showing the step 1 of the first preferred embodiment of the present invention.

FIG. 4 is a view showing the step 2 of the first preferred embodiment of the present invention.

FIG. 5 is a view showing the product of the first preferred embodiment of the present invention.

FIG. 6 is a perspective view of the joint component of the second preferred embodiment of the present invention.

FIG. 7A is a view showing the step 1 of the second preferred embodiment of the present invention.

FIG. 7B is a cross-sectional view showing the step 1 of the second preferred embodiment of the present invention.

FIG. 8 is a view showing the step 2 of the second preferred embodiment of the present invention.

FIG. 9 is a view showing the product of the second preferred embodiment of the present invention.

FIG. 10A illustrates the structural member of the first preferred embodiment of the present invention.

FIG. 10B illustrates the structural member of the second preferred embodiment of the present invention.

FIG. 11 is a view showing the product of the third embodiment of the present invention.

FIG. 12 shows the interlocking condition about the plastic material and the joint component.

### DETAILED DESCRIPTION OF THE PREFERRED EMBODIMENT

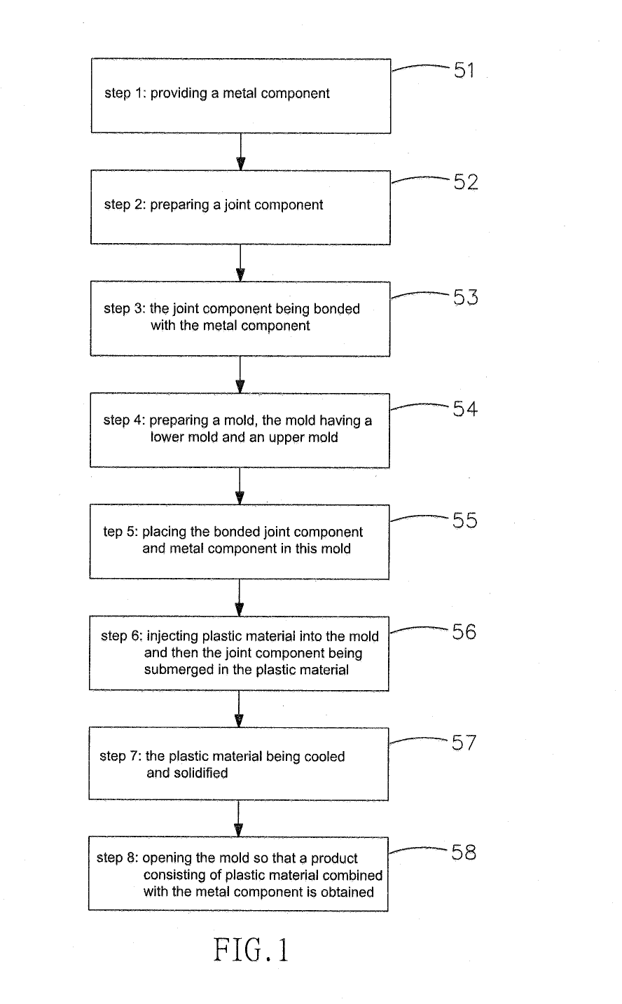

Referring to FIGS. 1 to 5, this invention is a method of selective plastic insert molding on metal component. It comprises the steps of:

step 1 (labeled 51): providing a metal component 10;

step 2 (labeled 52): preparing a joint component 20;

step 3 (labeled 53): the joint component 20 being bonded with the metal component 10;

step 4 (labeled 54): preparing a mold 30, the mold having a lower mold 31 and an upper mold 32;

step 5 (labeled 55): placing the bonded joint component 20 and metal component 10 in this mold 30;

step 6 (labeled 56): injecting plastic material 40 into the mold 30 and then the joint component 20 being submerged in the plastic material 40;

step 7 (labeled 57): the plastic material 40 being cooled and solidified; and

step 8 (labeled 58): opening the mold 30 so that a product consisting of plastic material 40 combined with the metal component 10 is obtained.

Based on the above-mentioned step 1 to step 8, the joint component 20 can be secured on the metal component 10, and then the plastic material 40 is injected to enclose the entire joint component 20. After the plastic material 40 is cooled and solidified, the joint component 20 and the metal component 10 are firmly engaged with the plastic material 40 (or called firmly-bonded together).

Of course, the product manufactured by the method of the above-mentioned step 1 to step 8 is claimed in this invention.

Concerning the metal component 10, it is preferably a housing member of mobile phone (or a housing member of an electronic product for at least partially enclosing electronic components). Under this condition, the thickness of this metal component 10 must be thin and light. Plus, its structure strength should be good and the surface is smooth. It can be made by stainless steel, aluminum alloy, aluminum-magnesium alloy, etc. Of course, the metal component 10 can be decorated or coated with a film, if it is needed.

The following description contains two different types of joint components 20 as two preferred embodiments of the present invention.

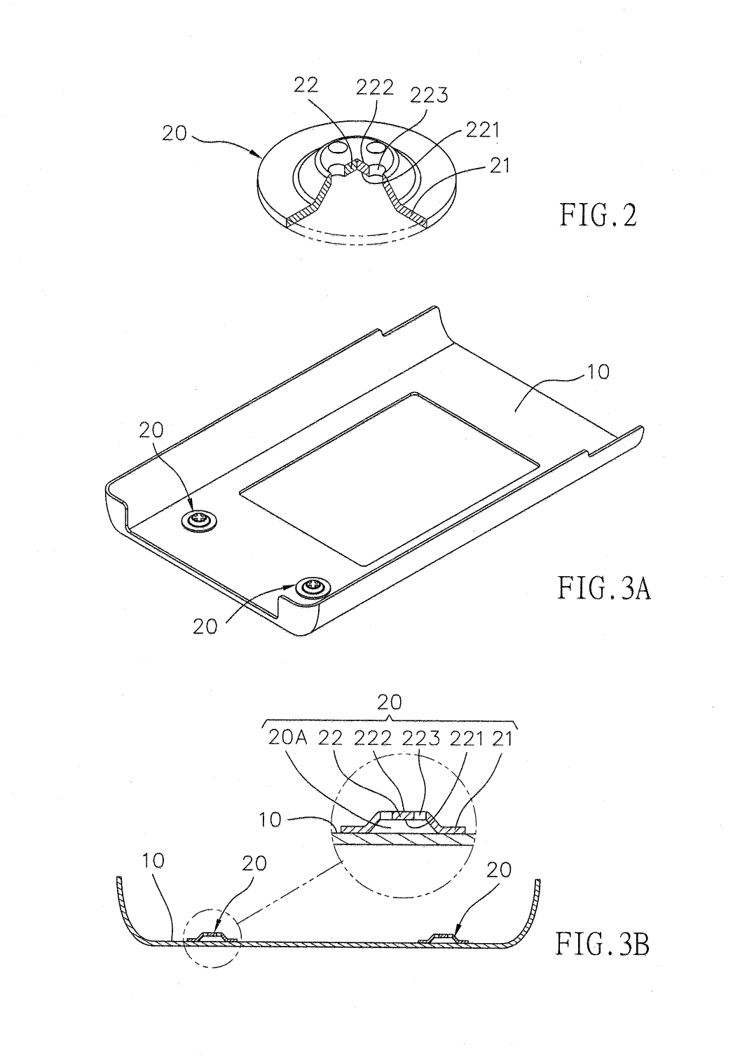

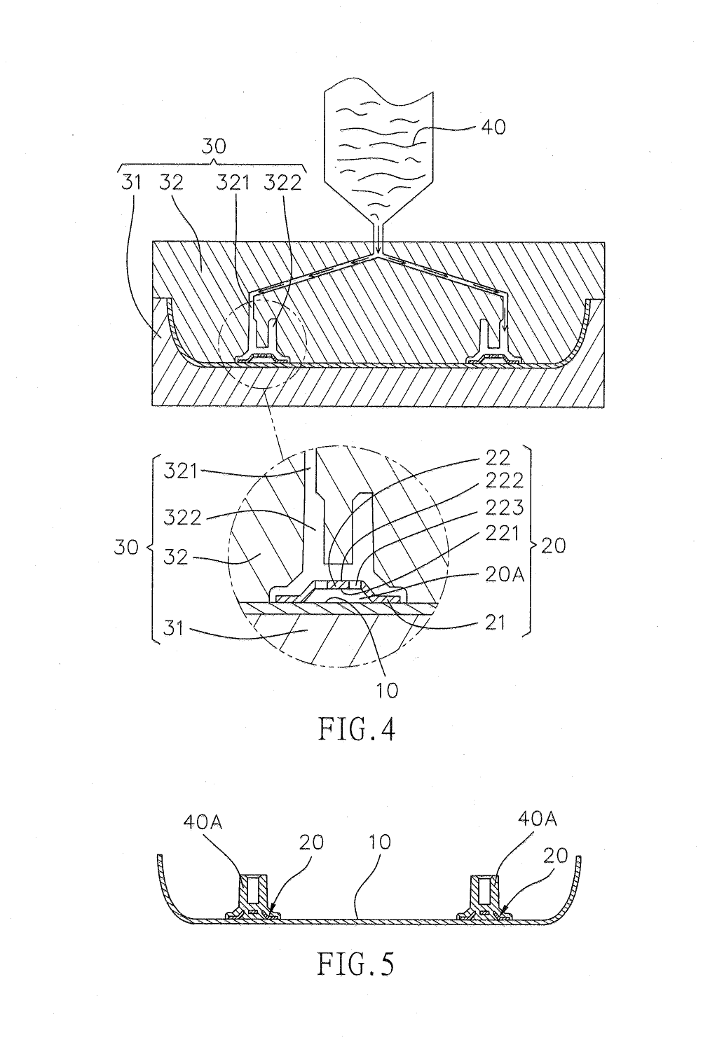

About the first preferred embodiment, as exhibited in FIG. 2, the joint component 20 has a connecting portion 21 and a securing portion 22. The connecting portion 21 is formed as a disk structure with a central protrusion. The peripheral portion is the connecting portion 21 and the central protrusion is the securing portion 22. The connecting portion 21 is provided for connecting with the metal component 10. The securing portion 22 has a first surface 221, a second surface 222, and at least one securing hole 223. This securing hole 223 is a through hole between the first surface 221 and the second surface 222. As illustrated in FIGS. 3A and 3B, after the connecting portion 21 of the joint component 20 is bonded to a bonding surface of the metal component 10, a predetermined space 20A is formed between the first surface 221 and the metal component 10. As shown in FIG. 4, the upper mold 32 contains a feeding channel 321 and at least one forming space 322. This forming space 223 is shaped as a screw seat. After which, the bonded structure consisted by the joint component 20 and the metal component 10 can be placed in the forming space 322 of the mold 30. During the plastic injection process, the plastic material 40 is injected into the forming space 322 via the feeding channel 321. Then, the plastic material 40 encloses the joint component 20 and passes through the securing hole 223. Hence, after the plastic material 40 is cooled and solidified, the mold 30 can be opened. The metal component 10 and the plastic material 40 are bonded together and a product is obtained (as shown in FIG. 5). In addition, the solid plastic material 40 forms a structural member 40A shaped as a screw seat (such as for securing a mobile phone's housing via a screw).

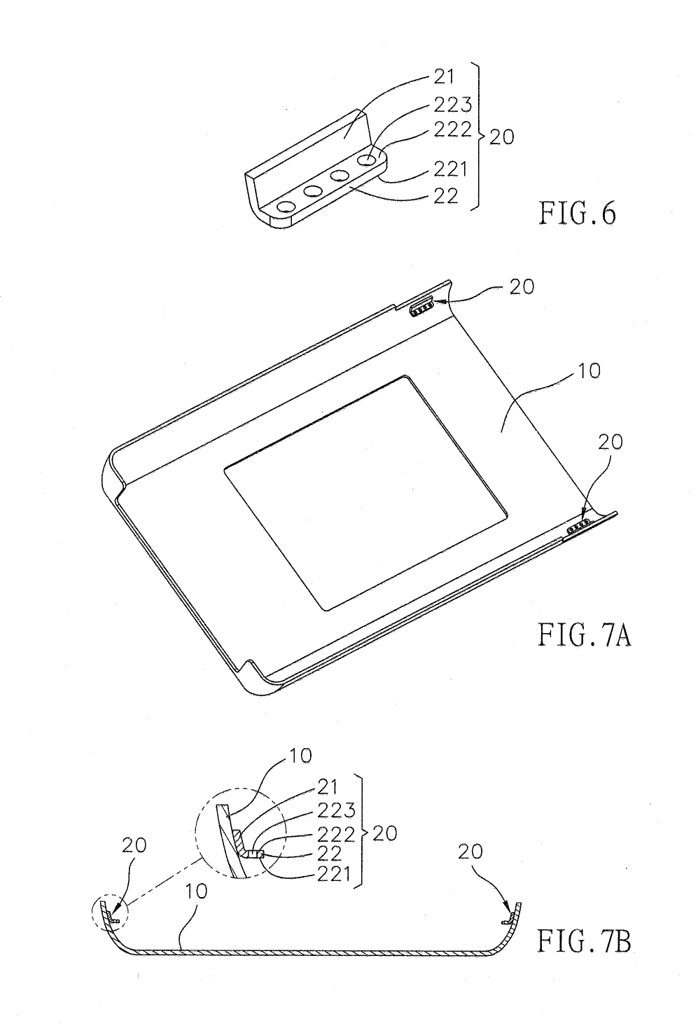

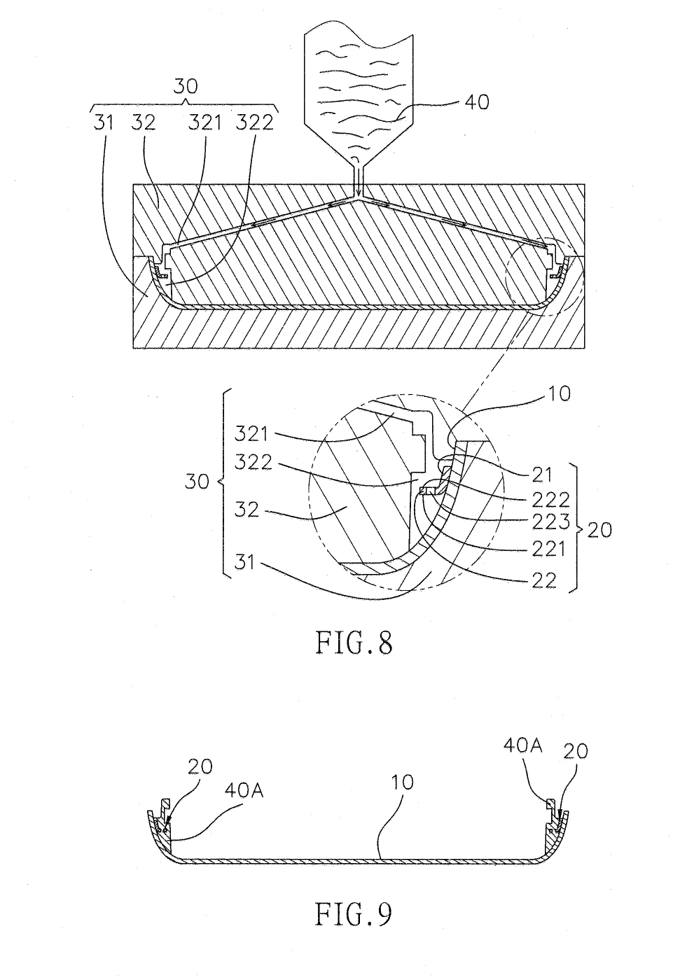

With regard to the second preferred embodiment, as illustrated in FIG. 6, the joint component 20 has a connecting portion 21 and a securing portion 22. The joint component 20 is an L-shaped plate punched by a press. A predetermined angle is formed between the connecting portion 21 and the securing portion 22. As illustrated in FIGS. 7A and 7B, the connecting portion 21 of the joint component 20 is bonded on the metal component 10. As shown in FIG. 8, the upper mold 32 contains a feeding channel 321 and at least one forming space 322. The forming space 322 of the upper mold 32 is formed as an engaging seat so as to allow the bonded structure consisted by the joint component 20 and the metal component 10 to be placed in the forming space 322. Then, the plastic material 40 is injected into the forming space 322 via the feeding channel 321. So, the plastic material 40 encloses the joint component 20 and passes through the securing holes 223. Hence, after the plastic material 40 is cooled and solidified, the mold 30 can be opened. The metal component 10 and the plastic material 40 are bonded together and a product is obtained (as shown in FIG. 9). In addition, the solid plastic material 40 forms a structural member 40A integral to the metal component, which is shaped as an engaging seat or boss for a screw (such as for locking a mobile phone's housing).

Of course, if a higher strength of stiffness is required, the joint component 20 can be modified as O shape, U shape, W shape, or X shape.

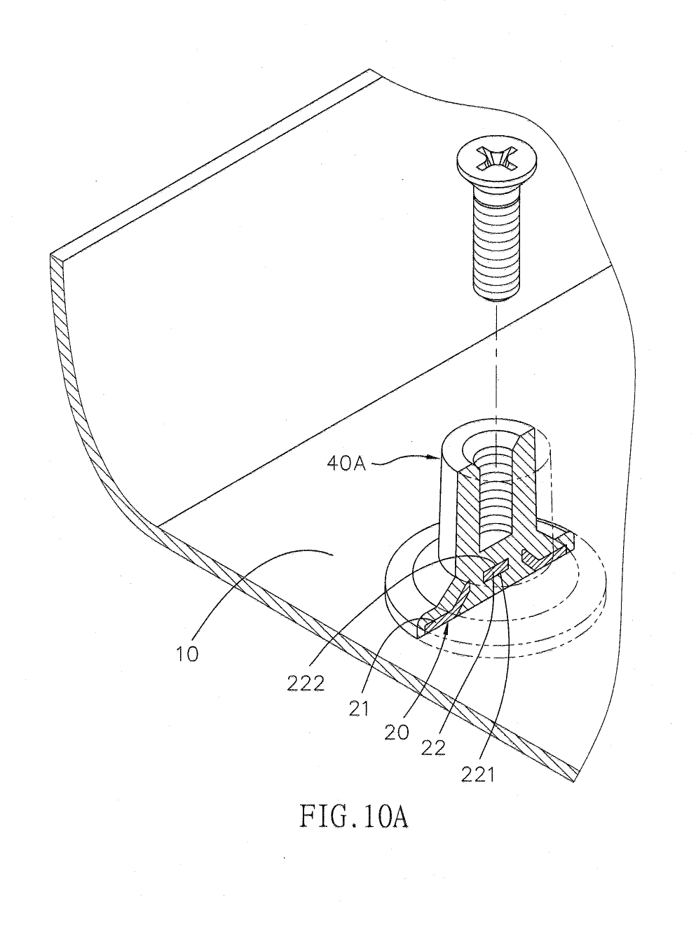

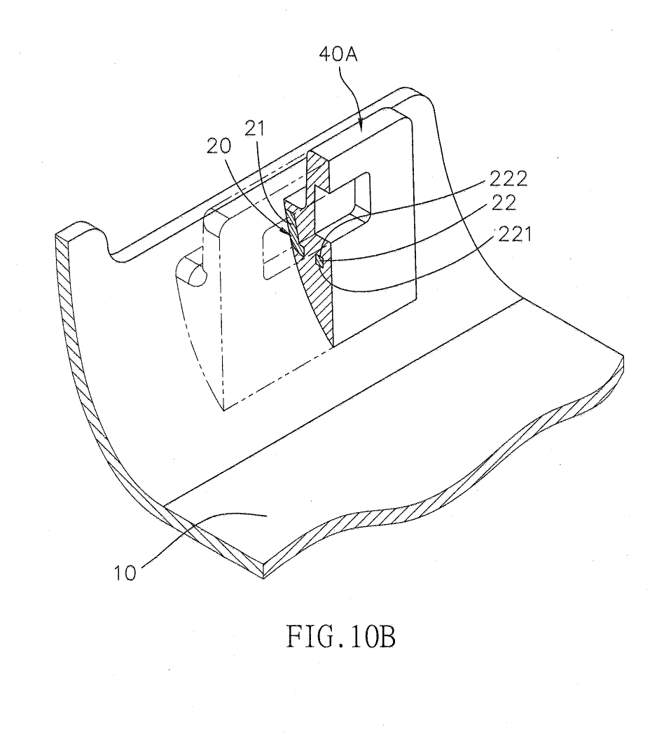

According to the first and second preferred embodiments, the joint component 20 and the forming space 322 can be modified depending on different requirements. The solidified plastic material 40 (that is the structural member 40A) with a predetermined shape and the metal component 10 are bonded together firmly via the joint component 20 (as illustrated in FIGS. 10A and 10B).

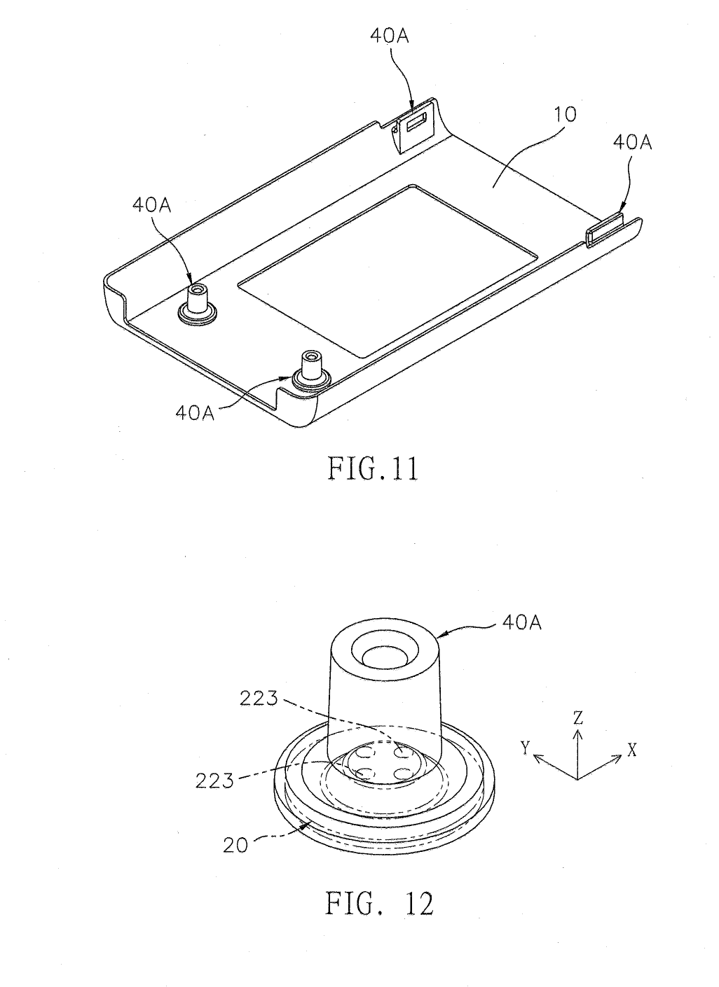

Referring to FIG. 11, it shows the third embodiment of the present invention. It is a combination of the first and the second preferred embodiments. Both the screw seat and the engaging seat are formed on the metal component 10, so that the screwing and locking functions can be achieved at the same time (for example, for assembling the metal housing of a mobile phone).

Relating to the bonding of the joint component 20 and the metal component 10, it can be achieved by laser welding, arc welding, adhesion (using glue or other adhesive), or other binding means. Besides, when it is done by laser welding or arc welding, the joint component 20 is made by stainless steel.

Moreover, once the structure of the joint component 20 and structural member 40A are bonded together, they are interlocked firmly in three directions (X, Y, and Z) and cannot be rotated. As depicted in FIGS. 10A and 12, the solidified structural member 40A is limited by the securing hole 223, so it cannot move in the X or Y directions. Meanwhile, the first surface 221 and the second surface 222 of the securing portion 22 limits the structural member 40A, so the structural member 40A cannot move in Z direction. Therefore, it cannot move in all of the three directions (X, Y and Z directions) and cannot rotate.

Furthermore, this invention also includes a product comprising:

a metal component 10 (or called metal housing member) for at least partially enclosing components, the metal component 10 having a bonding surface:

a joint component 20 welded or adhesively bonded to the metal component 10, the joint component 20 having a first surface 221 and a second surface 222 opposing to the first surface 221 wherein the first surface 221 is adjacent to and faces the bonding surface of the metal component 10, and the second surface 222 faces away from the bonding surface of the metal component, the joint component 20 having one or more through securing holes 223 extending from the first surface 221 to the second surface 222; and

a structural member 40A comprising plastic material overmolded onto the joint component 20 such that a portion of the plastic material extends through the one or more though securing holes 222 of the joint component 20 and is secured thereby to the metal component 10.

Therefore, the advantages and functions of the present invention can be summarized as follows.

[1] The joint component makes the plastic material and the metal component bonded together firmly. The conventional method cannot make the plastic material to be bonded on a metal surface. But, this invention utilizes a joint component 20 to be bonded on the metal component 10 first and then be enclosed by the plastic material 40 (which becomes the structural member 40 after cooling and solidification process). Because the structural member 40A is interlocked by the securing hole 223 and is limited by the first surface 221 and the second surface 222. Thus, the structural member 40A is interlocked with the joint component 20 tightly. Hence, the metal component 10 and the plastic material 40 can be bonded together firmly.

[2] The plastic structural member can be formed on the metal component. The conventional method cannot make a plastic component formed on a metal component. Only the pressing, die-casting or forging is possible to form a mechanic portion on the metal component. But, in this invention, the solidified plastic material 40 and the joint component 20 are bonded firmly, so the plastic structural member can be formed on the metal component 10.

[3] It can shorten the manufacturing time and lower the cost. If the conventional forging method is applied, it is possible to for a portion with different thickness. But, it must utilize the CNC machine to make it. It takes more manufacturing time and its manufacturing cost is relative high. But, this invention utilizes the mold 30 and the plastic material 40 for plastic injection. Not only it is fast, but also it can reduce the cost.

[4] The aesthetics and strength of the metal component can be retained. If a metal component is placed in a cavity of a mold, the metal component will be enclosed by plastic material in a conventional insert molding method. Hence, the outer surface of the metal component is totally covered by plastic material. The aesthetics and strength of the metal component are gone. However, in this invention, the joint component 20 is bonded on the metal component 10 first and be placed in a mold 30 for plastic injection. So, the most of the outer surface of the metal component 10 is not covered. Thus, the aesthetics and strength of the metal component can be retained.

While this invention has been particularly shown and described with references to the preferred embodiments thereof, it will be understood by those skilled in the art that various changes or modifications can be made therein without departing from the scope of the invention by the appended claims.

What is claimed is:

1. A method of selective plastic insert molding on metal component comprising the steps of:
step 1: providing a metal component;
step 2: preparing a joint component;
step 3: said joint component being bonded with said metal component;
step 4: preparing a mold, said mold having a lower mold and an upper mold;
step 5: placing said bonded joint component and metal component in said mold;
step 6: injecting plastic material into said mold and then said joint component being submerged in said plastic material;
step 7: said plastic material being cooled and solidified; and
step 8: opening said mold so that a product consisting of plastic material combined with said metal component is obtained.

2. The method as claimed in claim 1, wherein said joint component has a connecting portion and a securing portion, said connecting portion is provided for connecting with said metal component, said securing portion has a fist surface, a second surface, and at least one securing hole, said securing hole is a through hole between said first surface and said second surface.

3. The method as claimed in claim 2, wherein the upper mold contains a feeding channel and at least one forming space, said forming space is shaped as a screw seat, said plastic material is injected into said forming space via said feeding channel, the plastic material encloses the joint component and then said plastic material is cooled and solidified into a structural member, said structural member is interlocked by the securing hole and is limited by the first surface and the second surface so that said structural member is interlocked with the joint component tightly.

4. The method as claimed in claim 1, wherein said bonding of said joint component and said metal component laser is achieved by laser welding, arc welding, or adhesion.

5. The method as claimed in claim 1, wherein said joint component and said solidified plastic material are bonded together and interlocked firmly in three directions as well as cannot rotate.

6. The method as claimed in claim 4, wherein when it is achieved by laser welding or arc welding, said joint component is made by stainless steel.

7. The product manufactured by the method of claim 1.

8. A product comprising:
a metal component for at least partially enclosing components, the metal component having a bonding surface:
a joint component welded or adhesively bonded to the metal component, the joint component having a first surface and a second surface opposing to said first surface wherein the first surface is adjacent to and faces the bonding surface of the metal component, and the second surface faces away from the bonding surface of the metal component, the joint component having one or more through securing holes extending from the first surface to the second surface; and
a structural member comprising plastic material overmolded onto the joint component such that a portion of the plastic material extends through the one or more though securing holes of the joint component and is secured thereby to the metal component.
